(19) United States
(12) Patent Application Publication
(10) Pub. No.: US 2019/0392356 A1
(43) Pub. Date: Dec. 26, 2019

(54) OCCUPANCY SENSING SYSTEM FOR PERSONALIZED DESK RESERVATION

(71) Applicant: Robert Bosch GmbH, Stuttgart (DE)

(72) Inventors: Sirajum Munir, Pittsburgh, PA (US); Charles P. Shelton, Monroeville, PA (US); Hope McDonald, St. Charles, IL (US)

(21) Appl. No.: 16/148,219

(22) Filed: Oct. 1, 2018

Related U.S. Application Data
(60) Provisional application No. 62/689,510, filed on Jun. 25, 2018.

(51) Int. Cl. G06Q 10/02; G06K 9/00

(52) U.S. Cl. CPC G06Q 10/02; G06F 3/0482; G06K 9/00369; G06K 9/00771

(57) ABSTRACT

An occupancy sensing based system for personalized desk reservation is disclosed that enables a user to choose and book a desk that meets his or her preferences in terms of temperature, humidity, noise level, and light intensity using a smart phone app, a web browser, or the like. The system uses sensors deployed underneath or above desks to monitor the occupancy and environmental status of all the desks in a site. The system uses LPWAN (Low Power Wide Area Network) for collecting and aggregating sensor data. It can be useful in offices, academic buildings and libraries, restaurants, lounge areas, phone booths, nap rooms, fitness centers, and many other places, where occupancy pattern is dynamic.

This application claims the benefit of priority of U.S. provisional application Ser. No. 62/689,510, filed on Jun. 25, 2018 the disclosure of which is herein incorporated by reference in its entirety.

### FIELD

The device and method disclosed in this document relates to occupancy sensing and, more particularly, to an occupancy sensing system for personalized desk reservation.

### BACKGROUND

Unless otherwise indicated herein, the materials described in this section are not prior art to the claims in this application and are not admitted to the prior art by inclusion in this section.

As companies offer flexible working conditions, desk sharing is becoming a norm. When an associate visits a facility other than his or her home office, it is often difficult to find and secure an empty desk. It is even more difficult to find a desk with preferred room temperature, humidity, noise level, light intensity, and in a location near to the team with whom he or she is collaborating. What is needed is a system that enables an associate to more easily find a vacant desk that satisfies his or her needs and preferences.

### SUMMARY

An occupancy sensing system is disclosed. The occupancy sensing system comprises: a plurality of occupancy sensors, each occupancy sensor being installed at a respective desk of a plurality of desks and being associated with at least one seat at the respective desk, each occupancy sensor being configured to (i) monitor an occupancy of the associated at least one seat at the respective desk and (ii) monitor at least one environmental condition at the respective desk; and a server communicatively coupled to the plurality of occupancy sensors and configured to (i) receive occupancy data from the plurality of occupancy sensors indicating the occupancy of each seat at each desk in the plurality of desks, (ii) receive environmental data from the plurality of occupancy sensors indicating the at least one environmental condition at each desk in the plurality of desks, and (ii) transmit the occupancy data and the environmental data to a personal electronic device communicatively coupled to the server.

A further occupancy sensing system is disclosed. The occupancy sensing system comprises: a plurality of occupancy sensors, each occupancy sensor being installed at a respective desk of a plurality of desks at a site and being associated with at least one seat at the respective desk, each occupancy sensor being configured to monitor an occupancy of the associated at least one seat at the respective desk; and a server communicatively coupled to the plurality of occupancy sensors and configured to (i) receive occupancy data from the plurality of occupancy sensors indicating the occupancy of each seat of each desk in the plurality of desks, (ii) store in a memory a reservation schedule for each seat of each desk in the plurality of desks, the reservation schedule indicating times during which each seat of each desk in the plurality of desks is reserved and times during which each seat of each desk in the plurality of desks is available, and (iii) transmit the occupancy data and the reservation schedule to a personal electronic device communicatively coupled to the server.

### BRIEF DESCRIPTION OF THE DRAWINGS

The foregoing aspects and other features of the occupancy sensing system are explained in the following description, taken in connection with the accompanying drawings.

FIG. 1 is a diagrammatic view of an exemplary embodiment of an occupancy sensing system.

FIG. 2 is a diagrammatic view of an exemplary installation of an occupancy sensing device at a desk.

FIG. 3 is a block diagram of exemplary components of the occupancy sensing device(s) of FIGS. 1-2.

FIG. 4 is a block diagram of exemplary components of the server of FIG. 1.

FIG. 5 is a block diagram of exemplary components of the client device(s) of FIG. 1.

FIG. 6 shows an exemplary graphical user interface 400 that may be displayed on a client device.

FIG. 7 exemplary visualization 500 of the desk locations which may be color coded to convey information.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

In this disclosure, an occupancy sensing system for personalized desk reservation is described. The occupancy sensing based desk reservation system may be particularly useful in places or facilities in which the occupancy pattern is irregular and dynamic. One such environment, which is discussed in detail herein, is a workplace or similar facility in which desks and other workspaces are flexibly assigned or unassigned, such that desk usage is highly dynamic. It will be appreciated, however, that the system is similarly applicable to other environments. Some other environments in which for personalized desk reservation would be useful include: (1) academic buildings and libraries, in which the system can enable students to reserve an empty desk and quiet area to study; (2) restaurants, in which the system can enable customers to reserve a table that matches their preferences; and (3) other common areas such as lounge areas, phone booths, nap rooms, fitness centers, and the like, in which the system can enable managers to improve utilization of such spaces. Additionally, in offices, call centers, customer service centers, or the like, the system can be used to determine if a particular employee can be found at his or her desk. Similarly, in some offices, a large display can be shown at a front desk to show who sits where and whether the person is currently available at his or her desk in a 3D Building Information Model (BIM) based floor plan. Furthermore, building operators can reduce cost by improving energy efficiency of buildings by controlling HVAC and lights using real-time occupancy information. Similarly, facility management division can manage janitorial maintenance effort based on actual utilization of spaces.

It will be appreciated that several challenges exist in personalized desk reservation. Particularly, the system should to be simple and cost effective for building operators to maintain, as well as easy for end users to use. For simple maintenance, any sensors at individual desks should to run on battery power with low enough power usage to operate for several years without a battery replacement. For easy and cost effective installation, the sensors should to be wireless with a transmission range large enough so that a receiver unit is not needed at every floor or for every couple of rooms. Additionally, the system should be privacy aware. Accordingly, cameras may not be appropriate for monitoring the presence of occupants. Furthermore, everyone in the workplace or other facility should have an opportunity to opt out from the system such that his or her desk is not monitored, either permanently or for a limited time period. Conventional solutions for desk reservation do not address the aforementioned challenges.

The occupancy sensing system for personalized desk reservation described herein addresses the aforementioned challenges by providing occupancy sensing devices that provide real-time, non-privacy invasive, occupancy and environmental sensing at each desk. Occupancy and environmental information is accessible by associates on the go from anywhere around the globe via a mobile device for the purpose of personalized desk reservation. In at least one embodiment, the occupancy sensing devices utilize LPWAN (Low Power Wide-Area Network), preferably LoRa™ radio to enable low power usage and long battery life making maintenance and installation simple and cost-effective.

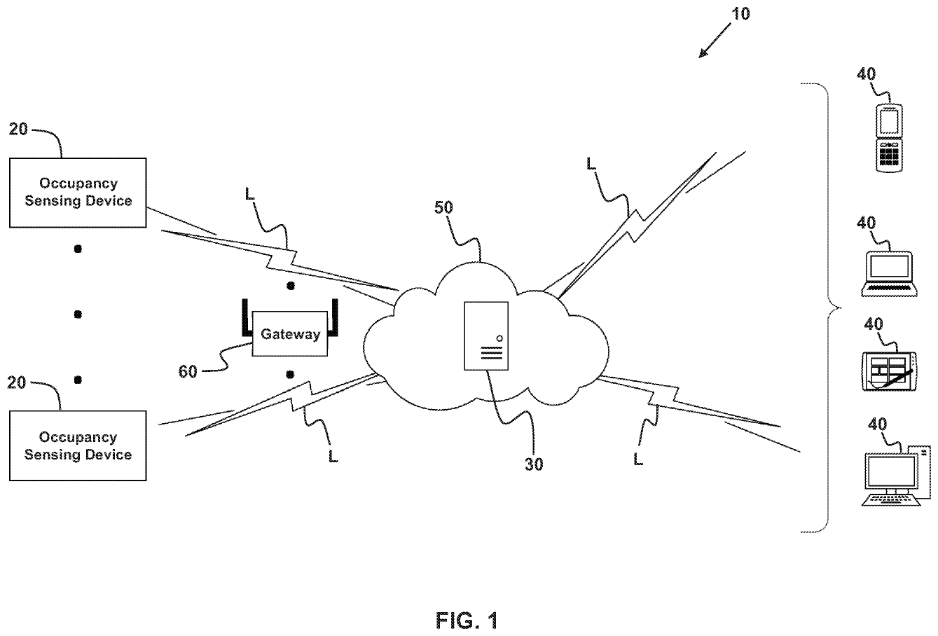

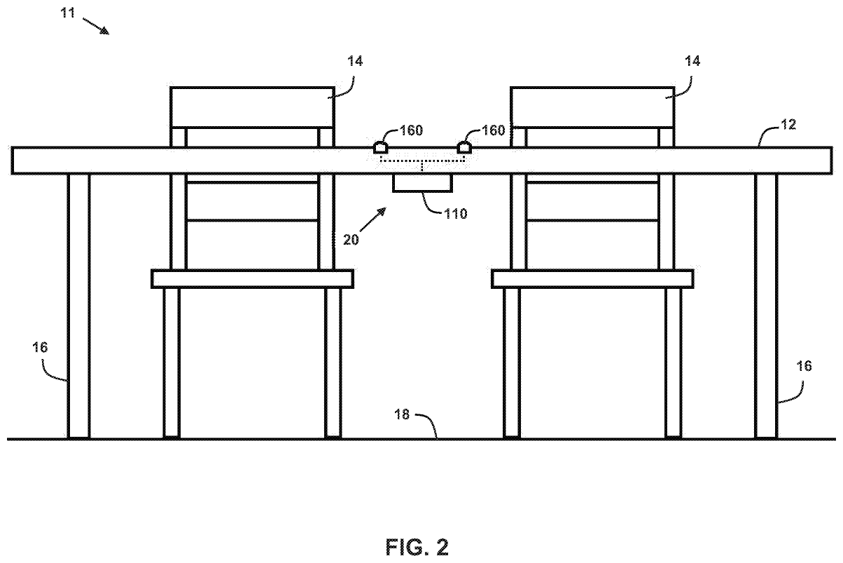

With reference to FIGS. 1-2, an exemplary embodiment of a desk reservation system 10 is described. As shown in FIG. 1, the desk reservation system 10 includes a plurality of occupancy sensing devices 20, each associated with a respective desk at a site or facility. Exemplary sites include academic campuses, business/office campuses, restaurants, cafeterias, stadiums, theaters, convention centers, or any other sites have shared desks or seating. Each occupancy sensing device 20 is configured to monitor the occupancy of one or more seats at the associated desk, as well as environmental conditions at the desk, such as noise level, ambient temperature, light intensity, and humidity.

The desk reservation system 10 further includes a server 30. The server 30 is configured to collect and process occupancy and environmental information provided by the occupancy sensing devices 20 in order to provide personalized desk reservation to users such as employees or customers of the facility. The server 30 may be an application server, a certificate server, a mobile information server, an e-commerce server, a FTP server, a directory server, CMS server, a printer server, a management server, a mail server, a public/private access server, a real-time communication server, a database server, a proxy server, a streaming media server, or the like.

The desk reservation system 10 further includes one or more client devices 40. The client devices 40 enable users, such as employees or customers of the facility, to view information regarding the occupancy and environmental conditions of each desk at the facility, to identify an available desk that meets his or her needs and preferences, and to reserve a selected or suggested desk at the facility. Each client device 40 may be a personal computer or desktop computer, a laptop, a cellular or smart phone, a tablet, a personal digital assistant (PDA), a wearable device, a gaming console, an audio device, a video device, an entertainment device such as a television, a vehicle infotainment, or the like.

The occupancy sensing devices 20, the server 30, and the client devices 40 are configured to communicate with one another via communication links L of a network 50. The communication links L may be wired, wireless, or combination thereof. The network 50 can comprise one or more sub-networks that work in concert to enable communication between the occupancy sensing devices 20, the server 30, and the client devices 40. The network 50 may comprise, in part, a pre-existing network such as enterprise-wide computer networks, intranets, internets, public computer networks, or any combination thereof. The network 50 may include for example a local-area network (LAN), a metropolitan area network (MAN), a wide area network (WAN), a primary public network with a private sub-network, a primary private network with a public sub-network, or a primary private network with a private sub-network 50. Still further embodiments of the network 50 may include network types such as a point to point network, a broadcast network, a telecommunication network, a data communication network, a computer network, an ATM (Asynchronous Transfer Mode) network, a SONET (Synchronous Optical Network) network, a SDH (Synchronous Digital Hierarchy) network, a wireless network, a wireline network, and the like. The particular network topology of the network 50 can differ within different embodiments which may include a bus network topology, a star network topology, a ring network topology, a repeater-based network topology, or a tiered-star network topology. Additional embodiments of the network 50 may utilize mobile telephone networks that use a protocol to communicate among mobile devices, where the protocol can be for example AMPS, TDMA, CDMA, GSM, GPRS, UMTS, LTE or any other protocol able to transmit data among mobile devices. A wireless communication link may include cellular protocol, data packet protocol, radio frequency protocol, satellite band, infrared channel, or any other protocol able to transmit data among devices of the network 50.

In at least one embodiment, the network 50 includes one or more wireless gateways 60 configured to wirelessly receive occupancy data and environmental data from the occupancy sensing devices 20 and to transmit the occupancy data and the environmental data to the server 30. In one embodiment, the wireless transmission of data between the occupancy sensing devices 20 and one or more wireless gateways 60 may utilize Low Power Wide-Area Network radio transmission, such as LoRa™.

With reference to FIG. 2, an exemplary installation of an occupancy sensing device 20 at a desk 11 is shown. In the illustrated installation, an occupancy sensing device 20 and/or a presence sensor 110 thereof, is mounted to and/or integrated with the desk 11. The occupancy sensing device 20 is mounted to and/or integrated with the desk 11 such that the presence sensor 110 thereof is arranged to view one or more seats 14 at the desk 11. For example, in the illustrated embodiment, the occupancy sensing device 20 and/or the presence sensor 110 thereof is mounted to and/or integrated with top portion 12 of the desk. The presence sensor(s) 110 can be mounted to and/or integrated with a bottom surface of the top portion 12 (as illustrated), or a top surface of the top portion 12 (not shown). However, it will be appreciated that, in alternative embodiments, the occupancy sensing device 20 and/or the presence sensor(s) 110 thereof can be mounted to and/or integrated with one of the legs 16 of the desk 11 or the floor 18 beneath the desk 11, depending on the methods used detect an occupancy of each seat 14 at the desk 11.

In at least one embodiment, each occupancy sensing device 20 is configured to monitor the occupancy of more than one seat at the desk. For example, in one embodiment, each occupancy sensing device 20 is configured to monitor up to four seats at an individual desk. If a desk includes more than four seats, then more than one occupancy sensing device 20 is integrated with the desk. For example, in one embodiment, if a desk has eight seats, then a first occupancy sensing device 20 monitors the occupancy of four of the seats at the desk and a second occupancy sensing device 20 monitors the occupancy of the other four seats at the desk. However, at least one occupancy sensing device 20 is integrated with each individual desk.

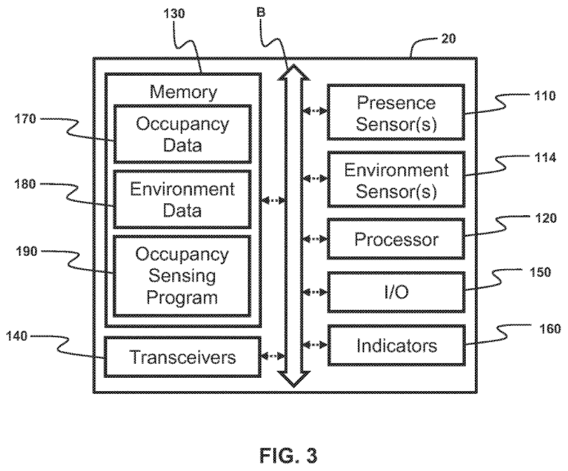

FIG. 3 illustrates a block diagram showing exemplary components of an occupancy sensing device 20 of FIGS. 1-2. In the illustrated embodiment, the occupancy sensing device 20 includes at least one presence sensor 110 (also shown in FIG. 2), at least one environment sensor 114, a processor 120, a memory 130, one or more transceivers 140, an input/output (I/O) interface 150, and at least one output device, such as indicator 160 (also shown in FIG. 2), which are communicatively coupled to one another via one or more system buses B. The system buses B may be any types of bus structures including a memory or a memory controller, a peripheral bus, a local bus, and any type of bus architectures. In at least one embodiment, the occupancy sensing device 20 further includes a battery (not shown) configured to provide power to the other components of the occupancy sensing device 20.

The processor 120 may be any of various processors as will be recognized by those of ordinary skill in the art. It will be recognized by those of ordinary skill in the art that a “processor” as used herein includes any hardware system, hardware mechanism or hardware component that processes data, signals, and/or other information. A processor can include a system with a central processing unit, multiple processing units, dedicated circuitry for achieving functionality, and/or other systems. Exemplary processors include microprocessors (μP), microcontrollers (μC), digital signal processors (DSP), or any combination thereof. The processor 120 may include one or more levels of caching, such as a level cache memory, one or more processor cores, and one or more registers. Example processor cores may include an arithmetic logic unit (ALU), a floating point unit (FPU), a digital signal processing core (DSP Core), or any combination thereof. In at least one embodiment, the processor 120 comprises a ARM processor. The processor 120 is operably connected to the presence sensor(s) 110, the environmental sensor(s) 114, the memory 130, the communication interface 140, the input/output interface 150, and the indicators 160 and is configured to receive the sensor data (pre-processed or otherwise) from the presence sensor(s) 110 and the environmental sensor(s) 114.

The at least one presence sensor 110 is configured to detect and/or monitor a presence of people sitting in one or more seats at the respective desk with which the occupancy sensing device 20 is integrated. In some embodiments, the presence sensor 110 includes one or more infrared (IR) sensors configured to measure infrared radiation, such as a passive infrared (PIR) sensor or an IR array sensor. In other embodiments, the presence sensor 110 includes one or more depth sensors configured to measure distances to a nearest object. The presence sensor 110 may comprise an array of individual sensor elements (not shown) arranged in a grid, each configured to detect a sensor value (e.g., an amount of IR radiation or a depth) and provide sensor data representing the detected sensor value. In one embodiment, the presence sensor 110 includes a readout controller (not shown) configured to control the individual sensor elements of the presence sensor 110, receive the sensor data from the individual sensor elements, and perform various pre-processing steps on the sensor data, such as digitizing the sensor data, timestamping the sensor data, and/or packaging the sensor data into image frames at a predetermined or adjustable framerate. It will be appreciated, however, that such processing by the readout controller can alternatively be performed by the processor 120 of the occupancy sensing device 20.

It will be appreciated that the usage of the IR or depth sensors is a much less privacy intrusive strategy for presence and occupancy sensing than many other solutions for presence and occupancy sensing. Particularly, IR sensors only measure infrared radiation and depth sensors only measure distances from the sensor to the nearest object. Hence, the occupancy sensing device 20 can, at most, see the shape of a human body but, unlike RGB camera based solutions, does not see the face, color of the clothes or hair, or other more uniquely identifying features of particular people occupying the seats. Additionally, as will be discussed in more detail below, only limited presence, occupancy, environmental, and/or reservation metadata is uploaded to the server 30. Thus, the solution is less privacy invasive because no images are stored or uploaded to the server 30. Furthermore, if the occupancy sensing devices 20 are compromised by a malicious actor, only infrared or depth sensor data, occupancy metadata, and/or environmental metadata would be compromised. However, it will be appreciated that more privacy-intrusive sensors, such as RGB cameras can be used in some alternative embodiments.

The at least one environmental sensor 114 is configured to detect and/or monitor at least one environmental condition at the respective desk with which the occupancy sensing device 20 is integrated. In some embodiments, the at least one environmental condition comprises one or more of noise level, ambient temperature, light intensity, and humidity. In some embodiments, the environmental sensors 114 include one or more of optical light sensors, imaging sensors, acoustic sensors, motion sensors, global positioning system (GPS) sensors, temperature sensors, humidity sensors, accelerometers, magnetometers, pressure sensors, or any other environmental sensors. In one embodiment, the environmental sensor 114 includes a readout controller (not shown) configured to control the individual sensor elements of the environmental sensor 114, receive the sensor data from the individual sensor elements, and perform various pre-processing steps on the sensor data, such as digitizing the sensor data, timestamping the sensor data, and/or packaging the sensor data into image frames at a predetermined or adjustable framerate. It will be appreciated, however, that such processing by the readout controller can alternatively be performed by the processor 120 of the occupancy sensing device 20.

The one or more transceivers 140 may be any of various devices configured for communication with other electronic devices, including the ability to send communication signals and receive communication signals. The transceivers 140 may include different types of transceivers configured to communicate with different networks and systems, at least including communication with the server via the communication links L of the network 50. The transceivers 140 may include, for example, a modem, a radio, a network interface, a communication port, a PCM-CIA slot and card, or the like. In one embodiment, the transceivers 140 are configured to exchange data using a protocol such as LoRa, Wi-Fi, Bluetooth, RFID, NFC, ZigBee, Z-Wave, or Ethernet.

In at least one embodiment, the transceivers 140 include a LPWAN (Low Power Wide-Area Network) transceiver, preferably a LoRa™ radio, to enable low power usage and long battery life making maintenance and installation simple and cost-effective. LoRa™ stands for Long Range wireless data telemetry, which provides an underlying technology for LPWAN that enables long-range communication at a low bit rate among Internet of Things devices. The LoRa™ transmitter can transmit up to 15 Km with line of sight, and up to 2 Km in urban areas.

The I/O interface 150 includes hardware and/or software configured to facilitate communications with the one or more peripherals and/or user interfaces, including indicators lights 160 (illustrated in FIGS. 2 and 3). In at least one embodiment, the indicator lights 160 are operated by the processor 120 to indicate whether a particular seat and/or desk is reserved or available. Other embodiments, may include other output devices, such as an a LCD display, a 7-segment number display, or a speaker which are operated to show reservation status or other useful information. Additional peripherals and/or user interfaces may include a keyboard, joystick, a mouse, a trackball, a touch pad, a touch screen or tablet input, a foot control, a servo control, a game pad input, an infrared or laser pointer, a camera-based gestured input, and the like capable of controlling different aspects of the operation of the occupancy sensing device 20.

The memory 130 of the occupancy sensing device 20 is configured to store information, including both data and instructions. The memory 130 may be of any type of device capable of storing information accessible by the processor 120, such as a memory card, ROM, RAM, write-capable memories, read-only memories, hard drives, discs, flash memory, or any of various other computer-readable medium serving as data storage devices as will be recognized by those of ordinary skill in the art. In at least one embodiment, the memory 130 includes occupancy data 170, such as a data regarding a current or previous occupancy of and/or presence of people at one or more seats of a desk at which the respective occupancy sensing device 20 is installed. In at least one embodiment, the memory 130 further includes environmental data 180, such as a data regarding a current or previous noise level, ambient temperature, light intensity, or humidity at the desk at which the respective occupancy sensing device 20 is installed. The data may further include various other operational data, logs, or the like.

The memory 130 is further configured to store program instructions that, when executed by the processor 120, enable the occupancy sensing device 20 to provide the features, functionality, characteristics and/or the like as described herein. Particularly, the memory 130 includes an occupancy sensing program 190 that enables monitoring of the occupancy of one or more seats of a desk at which the respective occupancy sensing device 20 is installed. Particularly, the processor 120 is configured to receive sensor data from the presence sensor(s) 110. In at least one embodiment, the processor 120 is configured to process the sensor data received from the presence sensor(s) 110 to determine whether a person is sitting in each of the one or more associated seats of the respective desk. Based this monitoring of whether people are present in the seats, the processor 120 is configured to determine whether the seat is occupied or unoccupied. In some embodiments, the processor 120 is configured to determine that the seat is unoccupied during any time that a person is not present in the seat and occupied during any time that a person is present in the seat. However, in many embodiments, the processor 120 is configured to determined that a seat is unoccupied if no person has been present in the seat for a predetermined threshold amount of time (e.g., the seat has been vacant for at least 5 minutes). Similarly, in many embodiments, the processor 120 is configured to determined that a seat is occupied if a person has been present in the seat for a predetermined threshold amount of time (e.g., a person has been sitting in the seat for at least 30 seconds). It will be appreciated that many different methods can be used to determine an occupancy of each seat based on the sensor data received by the presence sensor(s) 110.

The processor 120 is configured to store the received sensor data from the presence sensor(s) 110 and/or the determinations of the occupancy of each associated seat in the memory 130 (e.g., the occupancy data 170). Additionally, the processor 120 is configured to receive sensor data from the environmental sensors 114 and store the received sensor data in the memory 130 (e.g., the environmental data 180). The processor 120 is configured to operate one or more of the transceivers 140, such as the LoRa™ transmitter discussed above, to transmit and/or publish at least the occupancy data 170 and the environmental data 180 to the server 30. In at least one embodiment, data is transmitted and/or published to the server via the intermediate gateways 60. In some embodiments, other sensor data may also be transmitted or published to the server 30. In some embodiments, the transmitting and/or publishing of the occupancy data 170 and the environmental data 180 to the server 30 is performed periodically, according to a predetermined interval T (e.g., every 5 or 10 minutes). In one embodiment, the predetermined interval T is adjusted dynamically based on the time of data or based on the content of the sensor data. In one embodiment, the data is published using a pub-sub paradigm (e.g., XMPP, MQTT).

As discussed above, the desk reservation system 10 and/or the occupancy sensing devices 20 may include various output devices, such as the indicators 160. In one embodiment, at least one output device, such as the indicators 160, is associated with and connected to each respective occupancy sensing device 20. In one embodiment, the processor 120 is configured to operate one or more of the transceivers 140, such as the LoRa™ transmitter discussed above, to receive a reservation status of each seat associated with the respective occupancy sensing device 20 from the server 30. The received reservation status indicates whether a respective seat is reserved or available at the current time. The processor 120 is configured to operate the associated output device in to perceptibly indicate whether the at least one seat is reserved at the current time. For example, in one embodiment, the processor 120 is configured to operate the indicator 160 associated with a particular seat to be green or red, where green indicates that the seat is available and red indicates that the seat is currently reserved.

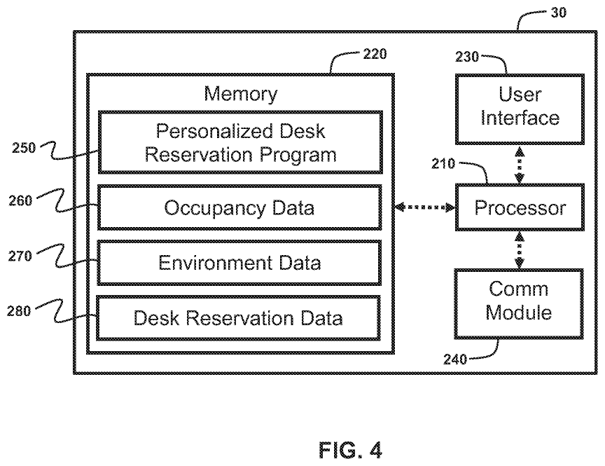

FIG. 4 illustrates a block diagram showing exemplary components of the server 30 of FIGS. 1-2. In the illustrated embodiment, the server 30 includes a processor 210, memory 220, a user interface 230, and a network communications module 240. It is appreciated that the illustrated embodiment of the server 30 is only one exemplary embodiment of a server 30 and is merely representative of any of various manners or configurations of a server, remote computer, or any other data processing systems that are operative in the manner set forth herein.

The processor 210 may be any of various processors as will be recognized by those of ordinary skill in the art. It will be recognized by those of ordinary skill in the art that a “processor” as used herein includes any hardware system, hardware mechanism or hardware component that processes data, signals, and/or other information. A processor can include a system with a central processing unit, multiple processing units, dedicated circuitry for achieving functionality, and/or other systems. Exemplary processors include microprocessors (μP), microcontrollers (μC), digital signal processors (DSP), or any combination thereof. The processor 210 may include one or more levels of caching, such as a level cache memory, one or more processor cores, and one or more registers. Example processor cores may include an arithmetic logic unit (ALU), a floating point unit (FPU), a digital signal processing core (DSP Core), or any combination thereof. The processor 210 is operably connected to the memory 220, a user interface 230, and a network communications module 240.

The server 30 may be operated locally or remotely by a user. To facilitate local operation, the server 30 may include an interactive user interface 230. Via the user interface 230, a user may modify and/or update program instructions stored on the memory 220, as well as collect data from and store data to the memory 220. In one embodiment, the user interface 230 may suitably include an LCD display screen or the like, a mouse or other pointing device, a keyboard or other keypad, speakers, and a microphone, as will be recognized by those of ordinary skill in the art. Alternatively, in some embodiments, a user may operate the server 30 remotely from another computing device which is in communication therewith via the network communication module 240 and has an analogous user interface.

The network communication module 240 of the server 30 provides an interface that allows for communication with any of various devices or networks and at least includes transceivers or other hardware configured to communicate with the occupancy sensing devices 20 and with the client devices 40. In particular, the network communications module 240 may include a local area network port that allows for communication with any of various local computers housed in the same or nearby facility. In some embodiments, the network communications module 240 further includes a wide area network port that allows for communications with remote computers over the Internet. Alternatively, the server 30 communicates with the Internet via a separate modem and/or router of the local area network. In one embodiment, the network communications module 240 is equipped with a Wi-Fi transceiver or other wireless communications device. Accordingly, it will be appreciated that communications with the server 30 may occur via wired communications or via the wireless communications. Communications may be accomplished using any of various known communications protocols.

The memory 220 of the server 30 is configured to store information, including both data and instructions. The memory 220 may be of any type of device capable of storing information accessible by the processor 210, such as a memory card, ROM, RAM, write-capable memories, read-only memories, hard drives, discs, flash memory, or any of various other computer-readable medium serving as data storage devices as will be recognized by those of ordinary skill in the art. In at least one embodiment, the memory 220 includes occupancy data 260, such as a data regarding a current or previous occupancy of and/or presence of people at each seat of each desk at which an occupancy sensing device 20 is installed. In at least one embodiment, the memory 220 further includes environmental data 270, such as a data regarding a current or previous noise level, ambient temperature, light intensity, or humidity at each desk at which an occupancy sensing device 20 is installed. In at least one embodiment, the memory 220 includes desk reservation data 280, such as a data regarding a reservation schedule and/or availability schedule for each seat of each desk at which an occupancy sensing device 20 is installed. The reservation schedule and/or availability schedule defines time periods during which respective seats are available and time periods during which respective seats are reserved. The data may further include various other operational data, logs, or the like.

The memory 220 is further configured to store program instructions that, when executed by the processor 210, enable the server 30 to provide the features, functionality, characteristics and/or the like as described herein. Particularly, the memory 220 includes a personalized desk reservation program 250 that enables real-time monitoring an occupancy and environment of each seat of each desk at the site via the client devices 40. Additionally, the personalized desk reservation program 250 enables user to search for available seats which satisfy his or her preferences for environmental conditions to make reservations of particular desks via the client devices and.

The processor 210 is configured to operate the network communication module 240 to receive the occupancy data 170 and the environmental data 190 from each respective occupancy sensing device 20 and store it in the memory 220 (e.g., the occupancy data 260 and the environmental data 270). In at least one embodiment, the data is received from the occupancy sensing devices 20 via the intermediate gateways 60. Furthermore, the processor 210 is configured to operate the network communication module 240 to transmit some or all of the occupancy data 260 and the environmental data 270 to one of the client devices 40 that is communicatively coupled to the server 30. In at least one embodiment, the transmission of some or all of the occupancy data 260 and the environmental data 270 to a particular client device 40 is performed in response to receiving a data request message from the particular client device.

In at least one embodiment, the processor 210 is configured to maintain and store a reservation schedule and/or availability schedule in the memory 220 (e.g., the desk reservation data 280). The reservation schedule and/or availability schedule defines time periods during which respective seats are available and time periods during which respective seats are reserved. Furthermore, in some embodiments, the processor 210 is configured to operate the network communication module 240 to transmit some or all of the reservation schedule and/or availability schedule to one of the client devices 40 that is communicatively coupled to the server 30. In at least one embodiment, the transmission of some or all of the reservation schedule and/or availability schedule to a particular client device 40 is performed in response to receiving a data request message from the particular client device.

In one embodiment, the processor 210 is configured to operate the network communication module 240 to receive a desk request message from a client device 40. The desk request message indicates that a user is seeking an available desk and may include a user preference for at least one environmental condition. For example, the desk request message may indicate that the user prefers a low noise and well-lit environment. In at least one embodiment, the user preference takes the form of a range of values, a maximum value, and/or a minimum value for one or more particular environmental conditions (e.g., noise level, ambient temperature, light intensity, and humidity). In response to receiving the desk request message, the processor 210 is configured to identify, based on the occupancy data 260 and the environmental data 270, one or more seats at one or more desks at the site that is currently unoccupied and for which the corresponding environmental conditions satisfies the user preference for the at least one environmental condition. For example, if the desk request message indicates that the user wants a desk having a noise level below a particular user defined maximum value, the processor 210 is configured to identify one or more seats that are currently available and have a noise level that is below the user defined maximum value. If no such desks exist, the processor 210 is configured to identify the available desks that come closest to satisfying the user preferences. Once the one or more desks have been identified, the processor 210 is configured to operate the network communication module 240 to transmit a list identifying the one or more desks that are currently unoccupied and for which the environmental condition(s) satisfy the user preferences.

In some embodiments, the desk request message received from a client device further identifies a particular time period during which a desk is requested, which may be a time period in the future. In response to receiving a desk request message identifying a particular time period in the future, the processor 210 is configured to identify, based on the reservation/availability schedule and the environmental data 270, one or more seats at one or more desks at the site that are available during the particular time period and for which the corresponding environmental conditions satisfies the user preference for the at least one environmental condition. Once the one or more desks have been identified, the processor 210 is configured to operate the network communication module 240 to transmit a list identifying the one or more desks that are available during the particular time period and for which the environmental condition(s) satisfy the user preferences.

In some embodiments, for the purpose of identifying seats that satisfy the user preferences for the environmental condition(s), the processor 210 is configured to compare a current environmental condition at the candidate seats and/or desks with the user defined preference for the environmental condition. However, in other embodiments, the processor 210 is configured to forecast the environmental condition at the candidate seats and/or desks based on historical environmental conditions at similar times of day on similar days, and compare the forecasted environmental condition at the candidate seats and/or desks with the user defined preference for the environmental condition.

In at least one embodiment, the processor 210 is configured to operate the network communication module 240 to receive a reservation request message from a client device 40. The reservation request message identifies a particular seat and/or desk which the user wishes to reserve and indicates a particular period of time during which the seat and/or desk is to be reserved. The processor 210 is configured to modify the reservation/availability schedule to indicate that the selected seat and/or desk is reserved during the selected time period. In some embodiments, the processor 210 is configured to first check if the selected seat is already reserved during the selected time period and, if there is a conflict, transmit a reservation failure message back to the client device 40.

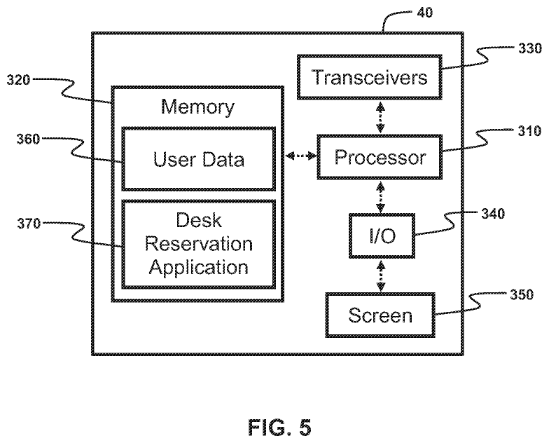

FIG. 5 shows an exemplary embodiment of one of the client devices 40, which may comprise a smart phone, a smart watch, a laptop computer, a tablet computer, desktop computer, or the like. In the illustrated embodiment, the client device 40 comprises a processor 310, a memory 320, transceivers 330, an I/O interface 340, and a display screen 350. It is appreciated that the illustrated embodiment of the client device 40 is only one exemplary embodiment of a client device 40 and is merely representative of any of various manners or configurations of a client device, a personal electronic device, or other device that is operative in the manner set forth herein.

The processor 310 may be any of various processors as will be recognized by those of ordinary skill in the art. It will be recognized by those of ordinary skill in the art that a “processor” as used herein includes any hardware system, hardware mechanism or hardware component that processes data, signals, and/or other information. A processor can include a system with a central processing unit, multiple processing units, dedicated circuitry for achieving functionality, and/or other systems. Exemplary processors include microprocessors (μP), microcontrollers (μC), digital signal processors (DSP), or any combination thereof. The processor 310 may include one or more levels of caching, such as a level cache memory, one or more processor cores, and one or more registers. Example processor cores may include an arithmetic logic unit (ALU), a floating point unit (FPU), a digital signal processing core (DSP Core), or any combination thereof. The processor 310 is operably connected to the memory 320, the transceivers 330, the I/O interface 340, and the display screen 350.

The transceivers 330 at least includes a transceiver, such as a Wi-Fi transceiver, configured to communicate with the server 30 via the network 50, but may also include any of various other devices configured for communication with other electronic devices, including the ability to send communication signals and receive communication signals. In one embodiment, the transceivers 330 further include additional transceivers which are common to smart phones, smart watches, laptop computers, tablet computers, desktop computers, such as Bluetooth transceivers, Ethernet adapters, and transceivers configured to communicate via for wireless telephony networks.

The I/O interface 340 includes software and hardware configured to facilitate communications with the one or more interfaces of the client device 40 including the display screen 350, as well as other interfaces such as tactile buttons, switches, and/or toggles, microphones, speakers, and connection ports. The display screen 350 may be an LED screen or any of various other screens appropriate for a personal electronic device. The I/O interface 340 is in communication with the display screen 350 and is configured to visually display graphics, text, and other data to the user via the display screen 350.

The memory 320 of the client device 40 is configured to store information, including both data and instructions. The memory 320 may be of any type of device capable of storing information accessible by the processor 310, such as a memory card, ROM, RAM, write-capable memories, read-only memories, hard drives, discs, flash memory, or any of various other computer-readable medium serving as data storage devices as will be recognized by those of ordinary skill in the art. In at least one embodiment, the memory 320 includes user data 360 which includes various types of user specific information such as user defined preferences for various environmental conditions (e.g., noise level, ambient temperature, light intensity, and humidity), an employee profile, a work schedule, or information regarding current seat and/or desk reservations for the user.

The memory 320 is further configured to store program instructions that, when executed by the processor 310, enable the client device 40 to provide the features, functionality, characteristics and/or the like as described herein. Particularly, the memory 320 includes a desk reservation application 370 that enables a user to view real-time occupancy and environmental data regarding each seat of each desk at the site. Additionally, the desk reservation application program 370 enables user to search for and reserve available seats which satisfy his or her preferences for environmental conditions via the client devices.

In some embodiments, the processor 310 is configured to operate the transceivers 330 to receive some or all of the occupancy data 260 and the environmental data 270 from the server 30. In some embodiments, the processor 310 is configured to operate the transceivers 330 to receive some or all reservation/availability schedule from the server 30. The processor 310 is configured to operate the display screen 350 to display a visualization of real-time occupancies, real-time environmental conditions, future reservation/availability schedules, and/or the locations of the desks at the site based on the received occupancy data 260 and environmental data 270.

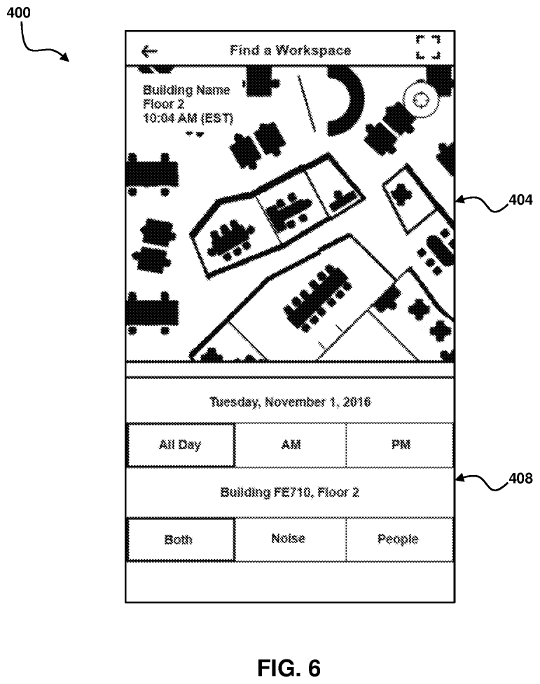

FIG. 6 shows one exemplary graphical user interface 400 that may be displayed on the display device 350 of the client device. The graphical user interface 400 includes a visualization 404 of the desk locations, which may be color coded (not shown) to convey occupancy, environmental, and/or reservation information. The graphical user interface 400 includes options 408 for filtering and/or customizing the visualization 400.

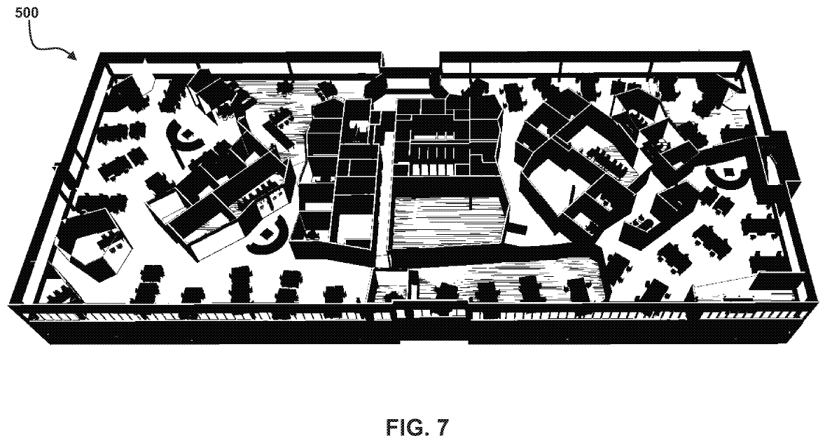

FIG. 7 shows a further exemplary visualization 500 of the desk locations, which may be color coded (not shown) to convey occupancy, environmental, and/or reservation information. In some embodiments, similar visualizations can be displayed on a large display device in a public area, such as in a lobby of the site at which the system is displayed. Such visualizations can be constructed based on a Building Information Model (BIM), which may be stored in the memory 220 at the server and/or the memory 320 of the client device 40.

Returning to FIG. 5, in at least one embodiment, the processor 310 is configured to receive inputs from a user via an input device connected to the I/O interface 340 indicating a user preference for one or more environmental conditions. As discussed above, each user preference may take the form of a range of values, a maximum value, and/or a minimum value for a particular environmental condition (e.g., noise level, ambient temperature, light intensity, and humidity).

In one embodiment, the processor 310 is configured to receive inputs from a user via an input device connected to the I/O interface 340 indicating that the user would like to find a desk. In response, the processor 310 is configured to operate the transceivers 330 to transmit the desk request message, as discussed above, which includes the user preferences and a particular time during which the user wants a desk. The processor 310 is configured to operate the transceivers 330 to receive a list of matching seats and/or desks from the server 30 which are available during the particular time and which satisfied the user preferences with respect to environmental conditions. Next, the processor 310 is configured to receive inputs from a user via an input device connected to the I/O interface 340 indicating which seat and/or desk the user would like to reserve and for what time period. The processor 310 is configured to operate the transceivers 330 to transmit a reservation request message, as discussed above, which indicates the seat and/or desk that is to be reserved for the user and the particular time during which seat and/or desk is to be reserved.

It will be appreciated that, in some embodiments, the client devices 40 are configured to perform the processes of identifying particular seats and/or desks that satisfy the needs of the user, in a similar manner as discussed above with respect to the server 30. Particularly, in some embodiments, the processor 310 is configured to identify, based on the received occupancy data 260 and environmental data 270 from the server 30, one or more seats at one or more desks at the site that are currently unoccupied and for which the corresponding environmental conditions satisfies the user preference for the at least one environmental condition. If no such desks exist, the processor 310 is configured to identify the available desks that come closest to satisfying the user preferences. Once the one or more desks have been identified, the processor 310 is configured to operate the display screen 350 to display a list identifying the one or more desks that are currently unoccupied and for which the environmental condition(s) satisfy the user preferences.

In some cases, the user wants to reserve a desk at a particular time period in the future. In in these cases, the processor 310 is configured to identify, based on the reservation/availability schedule and the environmental data 270 received from the server 30, one or more seats at one or more desks at the site that are available during the particular time period and for which the corresponding environmental conditions satisfies the user preference for the at least one environmental condition. Once the one or more desks have been identified, the processor 310 is configured to operate the display screen 350 to display a list identifying the one or more desks that are available during the particular time period and for which the environmental condition(s) satisfy the user preferences.

In some embodiments, for the purpose of identifying seats that satisfy the user preferences for the environmental condition(s), the processor 310 is configured to compare a current environmental condition at the candidate seats and/or desks with the user defined preference for the environmental condition. However, in other embodiments, the processor 310 is configured to forecast the environmental condition at the candidate seats and/or desks based on historical environmental conditions at similar times of day on similar days, and compare the forecasted environmental condition at the candidate seats and/or desks with the user defined preference for the environmental condition.

Next, the processor 310 is configured to receive inputs from a user via an input device connected to the I/O interface 340 indicating which seat and/or desk the user would like to reserve and for what time period. The processor 310 is configured to operate the transceivers 330 to transmit a reservation request message, as discussed above, which indicates the seat and/or desk that is to be reserved for the user and the particular time during which seat and/or desk is to be reserved.

The embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling with the sprit and scope of this disclosure.

While the patent has been described with reference to various embodiments, it will be understood that these embodiments are illustrative and that the scope of the disclosure is not limited to them. Many variations, modifications, additions, and improvements are possible. More generally, embodiments in accordance with the patent have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. An occupancy sensing system comprising:
a plurality of occupancy sensors, each occupancy sensor being installed at a respective desk of a plurality of desks and being associated with at least one seat at the respective desk, each occupancy sensor being configured to (i) monitor an occupancy of the associated at least one seat at the respective desk and (ii) monitor at least one environmental condition at the respective desk; and
a server communicatively coupled to the plurality of occupancy sensors and configured to (i) receive occupancy data from the plurality of occupancy sensors indicating the occupancy of each seat at each desk in the plurality of desks, (ii) receive environmental data from the plurality of occupancy sensors indicating the at least one environmental condition at each desk in the plurality of desks, and (ii) transmit the occupancy data and the environmental data to a personal electronic device communicatively coupled to the server.

2. The occupancy sensing system of claim 1, wherein the at least one environmental condition includes at least one of noise level, ambient temperature, light intensity, and humidity.

3. The occupancy sensing system of claim 1, wherein the server is configured to (i) receive a desk request message from the personal electronic device, the desk request message including a user preference for the at least one environmental condition, and (ii) identify, based on the occupancy data and the environmental data, at least one seat at a respective at least one desk in the plurality of desks that is currently unoccupied and for which the at least one environmental condition at the respective at least one desk satisfies the user preference for the at least one environmental condition.

4. The occupancy sensing system of claim 3, wherein the server is configured to transmit, to the personal electronic device, in response to the desk request message, a list identifying the at least one seat at the respective at least one desk in the plurality of desks that is currently unoccupied and for which the at least one environmental condition at the respective at least one desk satisfies the user preference for the at least one environmental condition.

5. The occupancy sensing system of claim 1, wherein the personal electronic device is configured to receive inputs from a user indicating a user preference for the at least one environmental condition.

6. The occupancy sensing system of claim 5, wherein the personal electronic device is configured to identify, based on the occupancy data and the environmental data, at least one seat at a respective at least one desk in the plurality of desks that is currently unoccupied and for which the at least one environmental condition at the respective at least one desk satisfies the user preference for the at least one environmental condition.

7. The occupancy sensing system of claim 1, wherein the server is configured to store in a memory a reservation schedule for each seat at each desk in the plurality of desks, the reservation schedule indicating time periods during which each seat at each desk in the plurality of desks is reserved and time periods during which each seat at each desk in the plurality of desks is available.

8. The occupancy sensing system of claim 7, wherein the server is configured to transmit the reservation schedule to the personal electronic device.

9. The occupancy sensing system of claim 8, wherein the server is configured to (i) receive a desk reservation message from the personal electronic device, the desk reservation message identifying a first seat at a first desk in the plurality of desks to be reserved and a first time period during which the first seat is to be reserved, and (ii) modify the reservation schedule to indicate that the first seat at the first desk is reserved during the first time period.

10. The occupancy sensing system of claim 7, wherein the server is configured to (i) receive a desk request message from the personal electronic device, the desk request message including a user preference for the at least one environmental condition and a first time period during which a desk is requested, and (ii) identify, based on the reservation schedule and the environmental data, at least one seat at a respective at least one desk in the plurality of desks that is available during the first time period and for which the at least one environmental condition at the respective at least one desk satisfies the user preference for the at least one environmental condition.

11. The occupancy sensing system of claim 10, wherein the server is configured to transmit, to the personal electronic device, in response to the desk request message, a list identifying the at least one seat at the respective at least one desk in the plurality of desks that is currently unoccupied and for which the at least one environmental condition at the respective at least one desk satisfies the user preference for the at least one environmental condition.

12. The occupancy sensing system of claim 7, wherein the personal electronic device is configured to receive inputs from a user indicating a user preference for the at least one environmental condition.

13. The occupancy sensing system of claim 12, wherein the personal electronic device is configured to identify, based on the reservation schedule and the environmental data, at least one seat at a respective at least one desk in the plurality of desks that is available during the first time period and for which the at least one environmental condition at the respective at least one desk satisfies the user preference for the at least one environmental condition.

14. The occupancy sensing system of claim 7 further comprising:
a plurality of output devices, each output device being associated with and connected to a respective occupancy sensor in the plurality of occupancy sensor,
wherein each occupancy sensor in the plurality of occupancy sensors is configured to (i) receive a reservation status of the at least one seat at the respective desk from the server, the reservation status indicating whether the at least one seat is reserved at a current time and (ii) operate the associated output device in the plurality of output devices to perceptibly indicate whether the at least one seat is reserved at the current time.

15. The occupancy sensing system of claim 1, wherein each occupancy sensor in the plurality of occupancy sensors comprises at least one of an infrared sensor and a depth sensor configured to monitor the occupancy of the associated at least one seat at the respective desk.

16. The occupancy sensing system of claim 1, wherein the personal electronic device is configured to display a visualization of locations and current occupancies of the plurality of desks on a display of the personal electronic device based on the received occupancy data.

17. The occupancy sensing system of claim 1 further comprising:
at least one wireless gateway configured to wirelessly receive the occupancy data and the environmental data from the plurality of occupancy sensors and transmit the occupancy data and the environmental data to the server,
wherein each occupancy sensor in the plurality of occupancy sensors has a wireless transmitter configured to wirelessly transmit the occupancy data and the environmental data to the at least one wireless gateway.

18. The occupancy sensing system of claim 17, wherein the wireless transmitter of each occupancy sensor in the plurality of occupancy sensors is a Low Power Wide-Area Network radio transmitter.

19. An occupancy sensing system comprising:
a plurality of occupancy sensors, each occupancy sensor being installed at a respective desk of a plurality of desks at a site and being associated with at least one seat at the respective desk, each occupancy sensor being configured to monitor an occupancy of the associated at least one seat at the respective desk; and
a server communicatively coupled to the plurality of occupancy sensors and configured to (i) receive occupancy data from the plurality of occupancy sensors indicating the occupancy of each seat of each desk in the plurality of desks, (ii) store in a memory a reservation schedule for each seat of each desk in the plurality of desks, the reservation schedule indicating times during which each seat of each desk in the plurality of desks is reserved and times during which each seat of each desk in the plurality of desks is available, and (iii) transmit the occupancy data and the reservation schedule to a personal electronic device communicatively coupled to the server.
